(19) United States
(12) Patent Application Publication
(10) Pub. No.: US 2015/0142523 A1
(43) Pub. Date: May 21, 2015

(54) METHOD, COMPUTER-READABLE STORAGE DEVICE AND APPARATUS FOR TRACKING AGGREGATE SUBSCRIBER AFFLUENCE SCORES

(71) Applicant: AT&T Mobility II LLC, Atlanta, GA (US)

(72) Inventors: MARK AUSTIN, Roswell, GA (US); Sheldon Kent Meredith, Marietta, GA (US); Rick Tipton, Corryton, TN (US)

(73) Assignee: AT&T Mobility II LLC, Atlanta, GA (US)

(21) Appl. No.: 14/086,888

(22) Filed: Nov. 21, 2013

(51) Int. Cl. G06Q 30/02

(52) U.S. Cl. CPC G06Q 30/0205
USPC 705/7.34

(57) ABSTRACT

A method, computer-readable storage device and apparatus for creating a map are disclosed. For example, the method receives location data for at least one subscriber of a communications network service provider, calculates an aggregate subscriber affluence score of the at least one subscriber, wherein the aggregate subscriber affluence score is based upon an affluence score weighted by an influence parameter, and creates the map representing a location that the at least one subscriber has visited with an indication of the aggregate subscriber affluence score of the at least one subscriber.

### BACKGROUND

Retailers are able to obtain useful information pertaining to customers visiting their stores, such as buying or browsing activities occurring within the retailers' stores, but the retailers have little information once the customers are outside their stores. For example, retailers spend thousands of dollars each year in accumulating data about the retailers' customers and/or potential customers. Typically, retailers will track purchases and spending habits of customers inside of their stores. However, this method of tracking does not allow the retailers to know whether there are potential customers outside of their stores.

Retailers can send out surveys to collect information, but such surveys can have low response rates and typically are processed slowly. Thus, information collected in the surveys can quickly become stale.

In addition, the retailers may collect data about customers inside their stores, but the retailers have little information as to the level of importance of each customer related to the retailers' business. In other words, retailers typically examine each consumer as an isolated individual and only evaluate the amount or the type of goods and services that the isolated individual is purchasing.

### SUMMARY

In one embodiment, the present disclosure provides a method, computer-readable storage device and apparatus for creating a map. In one embodiment, the method receives location data for at least one subscriber of a communications network service provider, calculates an aggregate subscriber affluence score of the at least one subscriber, wherein the aggregate subscriber affluence score is based upon an affluence score weighted by an influence parameter, and creates the map representing a location that the at least one subscriber has visited with an indication of the aggregate subscriber affluence score of the at least one subscriber.

### BRIEF DESCRIPTION OF THE DRAWINGS

The essence of the present disclosure can be readily understood by considering the following detailed description in conjunction with the accompanying drawings, in which:

FIG. 1 illustrates one example of a communications network of the present disclosure;

FIG. 2 illustrates a graphical representation of an affluence score and an influence;

FIG. 3 illustrates an example map of an aggregate subscriber affluence score;

FIG. 4 illustrates an example flowchart of a method for creating a map of an aggregate subscriber affluence score; and

FIG. 5 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present disclosure relates generally to calculating and tracking subscriber data and, more particularly, to a method, computer-readable storage device and apparatus for tracking aggregate subscriber affluence scores. As discussed above, retailers are able to obtain useful information pertaining to customers visiting their stores, such as buying or browsing activities occurring within the retailers' stores, but the retailers have little information once the customers are outside their stores. For example, retailers spend thousands of dollars each year in accumulating data about the retailers' customers and/or potential customers. Typically, retailers will track purchases and spending habits of customers inside of their stores. However, this method of tracking does not allow the retailers to know whether there are potential customers outside of their stores.

One embodiment of the present disclosure provides a “money map” or a “heat map of money” for retailers so that the retailers can see where affluent and influential individuals tend to spend their time. A communication service provider may collect location information of the subscribers and calculate an aggregate subscriber affluence score for each subscriber and display the combination of the location information and aggregate subscriber affluence score on a map (e.g., of a city, a town, a county, a state, and the like). Thus, the map can provide retailers valuable information about where the retailers should be advertising, where the retailers could open new locations and/or whether affluent and influential individuals are going to competitors of the retailers.

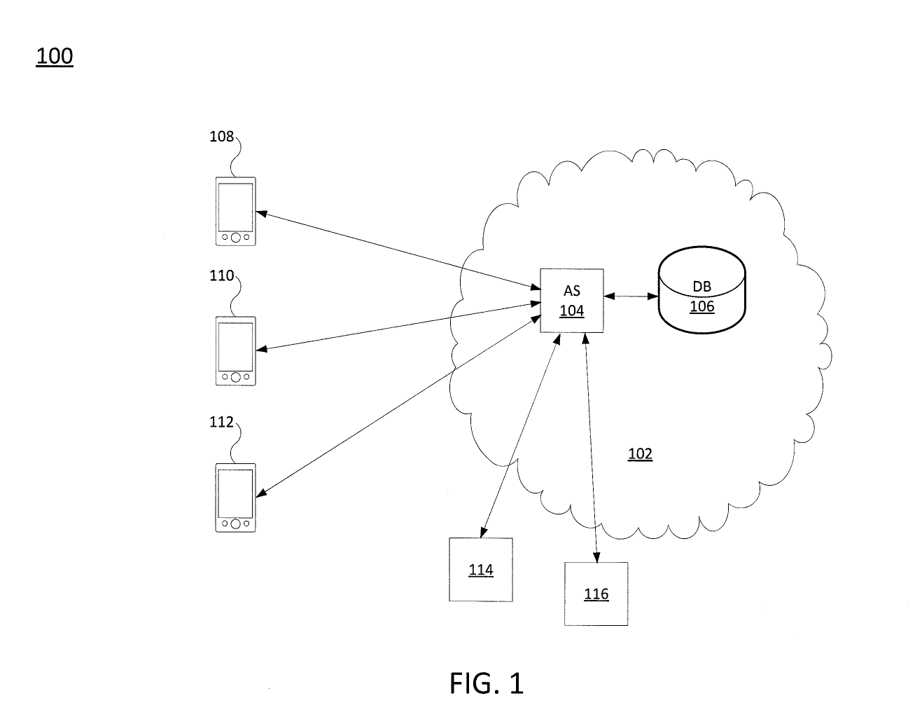

FIG. 1 is a block diagram depicting one example of a communications network 100. For example, the communication network 100 may be any type of communications network, such as for example, a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., 2G, 3G, and the like), a long term evolution (LTE) network, and the like related to the current disclosure. It should be noted that an IP network is broadly defined as a network that uses Internet Protocol to exchange data packets.

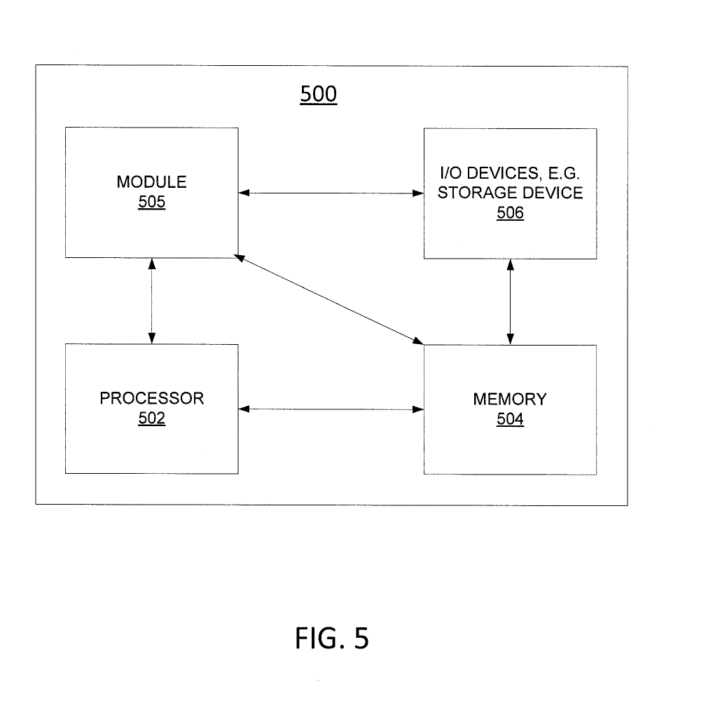

In one embodiment, the communications network 100 may include a core network 102. The core network 102 may include an application server (AS) 104. The AS 104 may be deployed as a server or a general purpose computer as illustrated in FIG. 5 and discussed below. In one embodiment, the AS 104 may be used to calculate an affluence score (a measure of influence on a subscriber's contacts) and aggregate a plurality of subscriber affluence scores and create the maps as disclosed herein.

The core network 102 may also include a database (DB) 106 in communication with the AS 104. The DB 106 may store information about each one of the subscribers of the communications network 100, e.g., location information about each one of the subscribers, demographic information of each one of the subscribers, affluence scores of each one of the subscribers, contact list information of each one of the subscribers, a communication history with each person on the contact list of each one of the subscribers, an aggregate subscriber affluence score of each one of the subscribers, and the like.

In one embodiment, the AS 104 may be in communication with one or more endpoint devices 108, 110 and 112 of the subscribers of the communications network 100. In one embodiment, the endpoint devices 108, 110 and 112 may be any type of mobile endpoint device, such as for example, a cell phone, a smart phone, a laptop computer, a tablet computer, a netbook computer, a mobile hotspot device, and the like. Although only three endpoint devices 108, 110 and 112 are illustrated in FIG. 1, it should be noted that any number of endpoint devices may be deployed.

In one embodiment, the endpoint devices 108, 110 and 112 may roam around a city or town as associated subscribers move from one location to another location. The AS 104 may collect the location data of each one of the endpoint devices 108, 110 and 112. Any type of location based services may be used to collect the location data. For example, a global positioning system (GPS) data collected by the endpoint devices 108, 110 and 112 may be forwarded to the AS 104, access points or cell towers used by the endpoint devices 108, 110 and 112 may be used to triangulate a location of the endpoint devices 108, 110 and 112 and sent to the AS 104, and the like.

In one embodiment, one or more third party retailers 114 and 116 may be in communication with the AS 104. In one embodiment, the third party retailers 114 and 116 may pay the communications network service provider for the maps that are created based upon the aggregate subscriber affluence scores. The retailers may use the maps to see where affluent and influential individuals are spending time within a given area, e.g., a particular region of a street, a neighborhood, a town, a city and the like.

In one embodiment, the communications network 100 may include additional access networks that are not disclosed. For example, the communications network 100 may include one or more access networks (not shown) such as a cellular network, a wireless fidelity (Wi-Fi) network, and the like. In one embodiment, the communications network 100 may also include additional network elements not shown to simplify the network illustrated in FIG. 1, such as for example, border elements, gateways, firewalls, routers, switches, call control elements, various application servers, and the like.

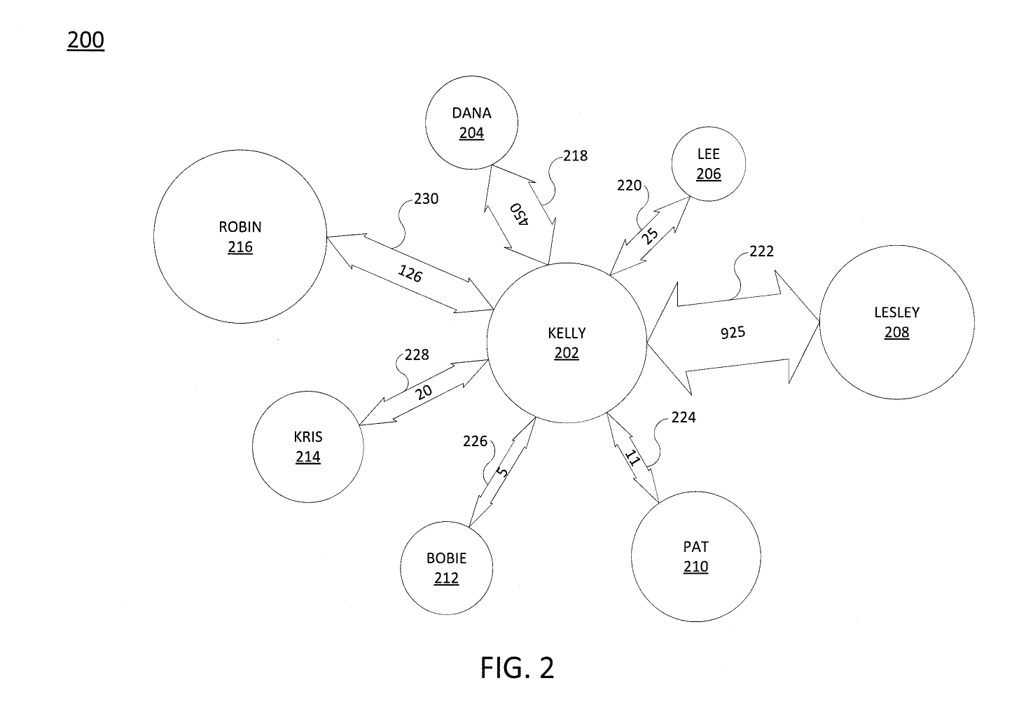

As discussed above, the AS 104 may be used to calculate an aggregate subscriber affluence score that is based on an affluence score and weighted by an influence that one subscriber has on a number of the subscriber's contacts. FIG. 2 illustrates a graphical representation 200 of an affluence score of a target user Kelly 202 and her contacts Dana 204, Lee 206, Lesley 208, Pat 210, Bobie 212, Kris 214 and Robin 216 and her influence on each one of her contacts. The size of the circles 202-216 of each name represents graphically an amount of affluence and a size of the arrows 218-230 between Kelly and each her contacts is related to her influence including a number of communications between Kelly and the respective contact.

In one embodiment, to calculate the affluence score of a subscriber, such as Kelly, and the influence of the subscriber on the subscriber's contacts, a top “n” number of contacts from Kelly's contact list may be used. In the example illustrated in FIG. 2, the top seven in Kelly's contact list is used and shown.

In one embodiment, the affluence score for Kelly and each one of her contacts Dana, Lee, Lesley, Pat, Bobie, Kris and Robin is calculated. In one embodiment, the AS 104 may use demographic information stored in the DB 106 about each one of the subscribers of the communications network 100 to calculate the affluence score. In one embodiment, various categories of the demographic information may be used. The various categories of the demographic information may include, for example, income (e.g., what is his or her annual salary), net worth (e.g., how much in total assets does the subscriber own), home ownership (e.g., does the subscriber own or rent), a neighborhood the subscriber lives in (e.g., is the address of the subscriber in an affluent area or a poor area), shopping habits (e.g., where does the subscriber shop, how much does the subscriber spend, e.g., by tracking shopping habits on the subscriber's mobile endpoint devices 108, 110 or 112, by tracking browsing data on the subscribers' mobile endpoint devices 108, 110 or 112, and the like), a credit score, a subscription package of the subscriber with the communications network service provider (e.g., does the subscriber have an expensive plan, a cheap plan, a business plan, an individual plan, and the like), and the like.

In one embodiment, the one or more of the various categories are used to calculate the affluence score. In one embodiment, the various categories are weighted based upon a third party retailer 114 or 116 that is requesting the map. For example, the third party retailer 114 may be an electronics store so the third party retailer may want to weight income and shopping habits higher than the other categories. In another example, the third party retailer 116 may be an insurance company and may want to weight home ownership and residing neighborhood of the subscriber higher than the other categories.

To illustrate an example, the third party retailer 114 that is an electronics store may request a map that weighs income and shopping habits higher than the other categories. The third party retailer 114 requests the categories of income, home ownership, neighborhood, shopping habits, credit score and cellular package to be used with each category having a weighting of 50%, 10%, 10%, 60%, 25% and 5%, respectively.

Kelly may have an income of $120K per year for a score of 85 out of 100, owns a home worth $300K for a score of 55 out of 100, lives in a relatively affluent zip code for a score of 70 out of 100, regularly spends $1000 a month for non-groceries for a score of 65 out of 100, has a credit score of 720 for a score of 60 out of 100 and has a cellular package of 4 lines with a monthly bill of $500 for a score of 90 out of 100. The weighting percentages specified by the third party retailer 114 may be used to boost the scores for each category accordingly. A sample calculation is illustrated in Table 1 below:

TABLE 1
SAMPLE AFFLUENCE SCORE CALCULATION

| | | | | | | Cell | |
|---|---|---|---|---|---|---|---|
| Target | In- | Home | Neigh- | Shopping | Credit | Pack- | |
| User | come | Owner | borhood | Habits | Score | age | Total |
| Affluence | 85 | 55 | 70 | 65 | 60 | 90 | 425 |
| Score - | | | | | | | |
| Kelly | | | | | | | |
| Weighting | 50% | 10% | 10% | 60% | 25% | 5% | |
| Boost | | | | | | | |
| Weighted | 127.5 | 60.5 | 77 | 104 | 75 | 94.5 | 538.5 |
| Affluence | | | | | | | |
| Score - | | | | | | | |
| Kelly | | | | | | | |

The affluence scores for each one of Kelly's contacts may be calculated in a similar fashion. It should be noted that the weighting percentages may vary depending on what categories are important to the third party retailer requesting the map. In one embodiment, a default weighting may weigh all of the categories equally to calculate the affluence score or no weighting may be used. It should be noted that the above example is only one scoring method and scoring scale that can be used. The scoring scale (e.g., score “x” out of 100, score “x” out of 1000, and the like) may be defined by the communications network service provider and should not be interpreted as a limitation of the present disclosure.

Once the affluence scores are calculated, the affluence scores of each one of Kelly's contacts may be weighted by an influence of the subscriber or target user on each one of the contacts to calculate the aggregate subscriber affluence score. In one embodiment, the influence may be a function of a number of communications with each one of the top “n” contacts of the target user. The communications may include any type of communications the target user has with the top “n” contacts, such as for example, a number of text messages, a number of multimedia messages, a number calls, and the like.

In one embodiment, some forms of communications may be weighted higher than other forms of communications. For example, text messages and multimedia messages may be weighted higher than phone calls because text messages and multimedia messages may indicate a more intimate relationship with higher influence.

Using the example in FIG. 2, Kelly has 450 communications with Dana, 25 communications with Lee, 925 communications with Lesley, 11 communications with Pat, 5 communications with Bobie, 20 communications with Kris and 126 communications with Robin. In addition, the affluence scores of Dana, Lee, Lesley, Pat, Bobie, Kris and Robin may be 230, 130, 500, 450, 300, 375 and 700, respectively. Notably, the influence is weighted based upon an amount of communications and an affluence of Kelly's contacts. Table 2 illustrates a sample calculation of the affluence score weighted by influence to calculate the aggregate subscriber affluence score for a target user.

TABLE 2
SAMPLE INFLUENCE WEIGHTING ON AFFLUENCE SCORE TO
CALCULATE AGGREGATE SUBSCRIBER AFFLUENCE SCORE

| | | | | SCORE = |
|---|---|---|---|---|
| | INDIVIDUAL | | % OF | WEIGHT × |
| | AFFLUENCE | | COMM. | AFFLUENCE |
| CONTACT | SCORE | # OF COMM. | (WEIGHT) | SCORE |
| Kelly | 538.5 | Target | Target | 538.5 |
| Kris | 375 | 20 | 1% | 5 |
| Lee | 130 | 25 | 2% | 2 |
| Lesley | 500 | 925 | 59% | 296 |
| Bobie | 300 | 5 | 0% | 1 |
| Dana | 230 | 450 | 29% | 66 |
| Robin | 700 | 126 | 8% | 56 |
| Pat | 450 | 11 | 1% | 3 |
| Sum | 3223.5 | 1562 | 100% | 967.5 |

In other words, the aggregate subscriber affluence score indicates that a target user is not only affluent, but also has a large influence over other contacts who are also affluent. As a result, these types of individuals may be more valuable to retailers than less affluent individuals or affluent individuals that have no contacts or contacts that are not affluent. Thus, the retailer may identify where these types of individuals are located on a map to focus their advertising or business effort.

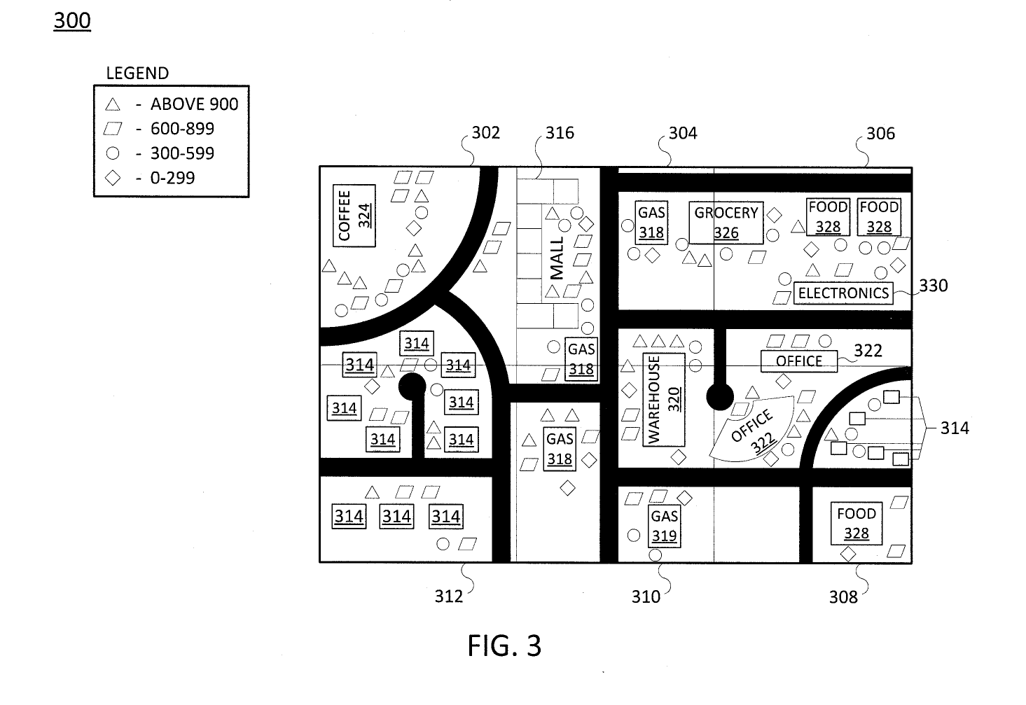

In one embodiment, the aggregate subscriber affluence scores may be calculated for any number of subscribers. The aggregate subscriber affluence scores can be then plotted on a map 300 as illustrated in FIG. 3. In one embodiment, the map 300 may be a portion of a street, a block, a neighborhood, a town, a city, a county, a state and the like. In one embodiment, the aggregate subscriber affluence scores may be divided into various different levels to produce a “heat map of money” for the desired area.

A different indication may be used for each different level of aggregate subscriber affluence scores. For example, in the map 300 the indications may include a triangle for scores above 900, a square for scores between 600-899, a circle for scores between 300-599 and a diamond for scores 0-299 as illustrated in a legend 350.

In one embodiment, the subscribers are represented anonymously on the map 300. However, an indication may be marked for each subscriber based upon his or her respective aggregate subscriber affluence scores and the locations that the subscriber has visited.

In one embodiment, to prevent cluttering the map 300 with too much information thereby diminishing the readability of the map, the map 300 may only include data for subscribers having an aggregate subscriber affluence score above a threshold. In another embodiment, the map 300 may only include data for subscribers that meet a threshold of a particular category of importance to a third party retailer 114 or 116 requesting the map. For example, the retailer 114 may be a clothing retailer and only wants data on subscribers that spend $500 a month or more on clothing, or the retailer 116 may be an appliance repair service and only wants data on subscribers that own a home or have a home worth more than $500,000, and the like.

In one embodiment, the map 300 may include a map of a region of a town or a city. The map 300 may include various residential buildings 314, a strip mall 316, gas stations 318, a warehouse club 320, office buildings 322, a coffee house 324, a grocery store 326, restaurants 328, an electronics store 330, and the like. It should be noted that other types of retailers, businesses and buildings may be located within the map 300. The various indications are plotted near the various locations on the map 300.

In one embodiment, the map 300 may be divided into one or more bins 302, 304, 306, 308, 310 and 312. Although the map 300 is divided into six bins, it should be noted that the map 300 may be divided into any number of bins. In one embodiment, the bins may have a pre-defined size that can be set by the communications service provider or the third party retailer 114 or 116 requesting the map. For example, the bins may each be 10 square miles, 100 square miles, and so forth. In one embodiment, if the map 300 is divided into bins, the location data of each one of the subscribers can be converted or mapped into the bins 302, 304, 306, 308, 310 and 312, accordingly.

In one embodiment, the map 300 may track locations of the subscribers over a pre-defined time period. For example, the pre-defined time period may be the last hour, 24 hours, last week, and so forth. An updated map 300 may be generated as each pre-defined time period elapses. In one embodiment, the map 300 may be updated continuously for a rolling pre-defined time period.

In another embodiment, the map 300 may track locations of the subscribers in real time. For example, the map 300 may continuously update the indications representing the various different aggregate subscriber influence scores in a live manner (i.e., as the movements of the subscribers are detected). As a result, a retailer that pays for and subscribes to the communications service provider for obtaining the map 300 may know when large group of affluent and influential individuals are proximate, e.g., outside their store or nearby, thereby allowing the retailer to dynamically send targeted advertisements.

In one embodiment, geo fences may be drawn around specific buildings. For example, the third party retailer 114 may be the owner of the electronics store 330. A geo fence may be drawn around the electronics store 330 to mark entries and exits of the electronics store 330 such that the third party retailer 114 can see graphically the concentration or density of the aggregate subscriber affluence scores near the electronics store.

Thus, in one embodiment of the present disclosure, the map 300 provides a map of affluence and how the “money” is moving around or where the “money” is traveling to within an area. In other words, the map 300 does not track individuals, but instead tracks the density of “influential money” (i.e., affluent individuals who have many contacts who are also affluent that the affluent individual has an influence on). Said another way, the map 300 may track those affluent individuals who may potentially influence other individuals to purchase products or services of a retailer or business. Thus, retailers or businesses may want to know where these types of individuals are and target these types of individuals for marketing or opening a new location that will likely be frequented by these individuals.

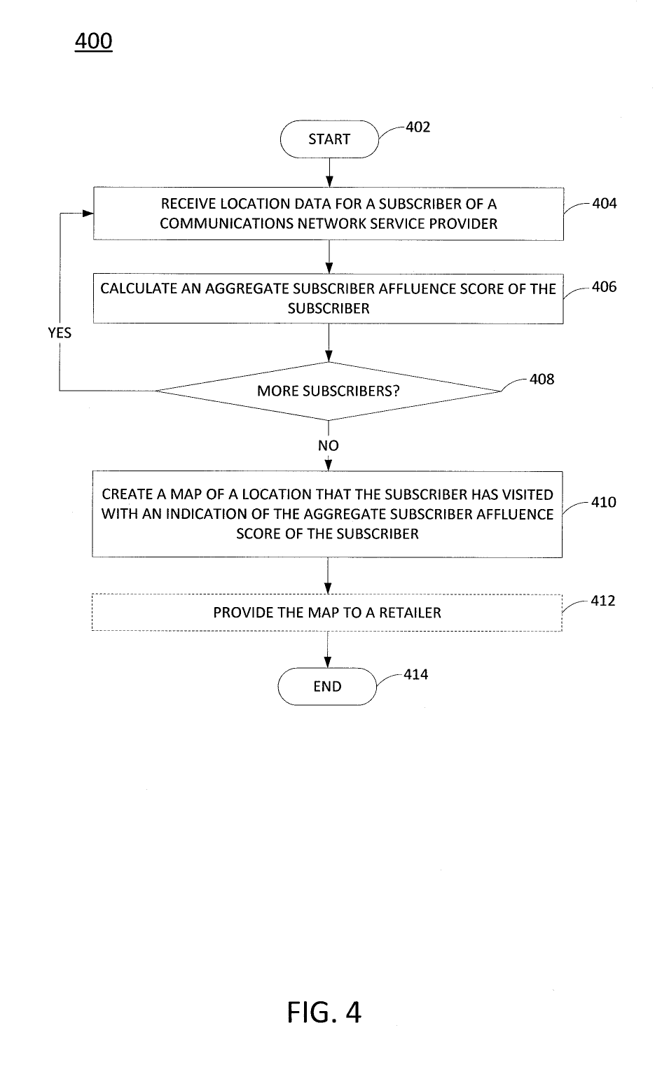

FIG. 4 illustrates a flowchart of a method 400 for creating a map reflecting one or more aggregate subscriber affluence scores. In one embodiment, the method 400 may be performed by the AS 104 or a general purpose computer as illustrated in FIG. 5 and discussed below.

The method 400 begins at step 402. At step 404, the method 400 receives location data for a subscriber of a communications network service provider. In one embodiment, the location data may be obtained by tracking a location of an endpoint device carried by or associated with the subscriber.

Any type of location based services may be used to collect the location data. For example, global positioning system (GPS) data collected by the endpoint devices may be forwarded to the AS 104, access points or cell towers used by the endpoint devices may be used to triangulate locations of the endpoint devices and sent to the AS 104, and the like.

At step 406, the method 400 calculates an aggregate subscriber affluence score of the subscriber. In one embodiment, the aggregate subscriber affluence score may be an affluence score of the subscriber and an affluence score of one or more contacts of the subscriber that are weighted by an influence that the subscriber has on one or more contacts of the subscriber.

In one embodiment, the aggregate subscriber affluence score may be based upon one or more different categories of demographic information about the subscriber. In one embodiment, one or more of the categories may be weighted based on a third party retailer requesting the map. For example, depending on the type of third party retailer, some categories (e.g., income and shopping habits) may be weighted more heavily than other categories (e.g., home ownership, neighborhood, credit score, subscription package, and the like).

In one embodiment, the influence of the subscriber on his or her contacts may be a function of a number of communications with each one of a predefined number of a plurality of contacts of the subscriber and a respective affluence score of each one of the predefined number of the plurality of contacts. For example, the subscriber may have 100 contacts. However, the aggregate subscriber affluence score may be based upon the subscriber's influence over the 10 contacts out of 100 who have the most communications with the subscriber.

In addition, the respective affluence of each one of the predefined number of the plurality of contacts is weighted by the number of communications between the contact and the subscriber. In other words, the aggregate subscriber affluence score takes into account not only the affluence of the subscriber, but the subscriber's influence on other affluent contacts of the subscriber.

Any method may be used to generate the aggregate subscriber affluence score. One example method is described above and provided in TABLE 1 and TABLE 2. It should be noted that the examples described in TABLE 1 and TABLE 2 are provided as example embodiments and should not be considered as limiting.

At step 408, the method 400 determines whether there are more subscribers having location data that can be received and requiring calculation of their aggregate subscriber affluence scores. For example, the map may be created for a plurality of subscribers, where each one of the plurality of subscribers has a respective calculated aggregate subscriber affluence score and with location data that is continuously or periodically tracked. If there are more subscribers, the method 400 may return to step 404 and repeat steps 404 and 406 until there are no more additional subscribers.

At step 408, if there are no more subscribers, the method 400 may proceed to step 410. At step 410, the method 400 creates a map that reflects the locations that the tracked subscribers have visited with an indication of the aggregate subscriber affluence score of each respective subscriber. An example map is illustrated in FIG. 3.

A different indication may be used for each different level of aggregate subscriber affluence scores. For example, in the map the indications may include a triangle for scores above 900, a square for scores between 600-899, a circle for scores between 300-599 and a diamond for scores 0-299. In another embodiment, the indications may be represented with different colors to indicate different levels of aggregate subscriber affluence scores.

In one embodiment, the subscribers may be represented anonymously on the map. However, an indication may be marked for each subscriber based upon his or her respective aggregate subscriber affluence score and the locations the respective subscriber has visited.

In one embodiment, to prevent cluttering the map with too much information, the map may only include data for subscribers having an aggregate subscriber affluence score that is above a predefined threshold, or between ranges of aggregate subscriber affluence scores. In another embodiment, the map may only include data for subscribers that meet a threshold of a particular category of importance to a third party retailer requesting the map. For example, a clothing retailer may only want data on subscribers that spend $500 a month or more on clothing or an appliance repair service may only want data on subscribers that own a home or have a home worth more than $500,000, and the like.

In one embodiment, the map may include a map of a portion of a region of a town or a city. The map may include various residential buildings, a strip mall, gas stations, a warehouse club, office buildings, a coffee house, a grocery store, restaurants, an electronics store, and the like. It should be noted that other types of retailers, businesses and buildings may be located within the map. The various indications are plotted near the various locations on the map.

In one embodiment, the map may be divided into one or more bins of geographic size. In one embodiment, the bins may have a pre-defined size that can be set by the communications service provider or the third party retailer. For example, the bins may each be 10 square miles, 100 square miles, and so forth. In one embodiment, if the map is divided into bins, the location data of each one of the subscribers may be converted or mapped into the bins accordingly.

In one embodiment, the map may track locations of the subscribers over a pre-defined time period. For example, the pre-defined time period may be the last hour, last 8 hours, 24 hours, last week, and so forth. An updated map may be generated as each pre-defined time period elapses. In one embodiment, the map may be updated continuously for a rolling pre-defined time period.

In another embodiment, the map may track locations of the subscribers in real time. As a result, a retailer that pays for and subscribes to the communications service provider for obtaining the map may know when large group of affluent and influential individuals are near the retailer's store.

In one embodiment, geo fences may be drawn around specific buildings. For example, the third party retailer may be the owner of an electronics store on the map. A geo fence may be drawn around the electronics store to mark entries and exits of the electronics store such that the third party retailer can graphically see the density of subscribers with their respective aggregate subscriber affluence scores near the electronics store.

At optional step 412, the method 400 may provide the map to a retailer. For example, the communications network service provider may create a map in response to a request from a third party retailer. The map may be weighted in accordance with the retailer's requirements and sold to the retailer as a service. Thus, the retailer may have knowledge of when affluent and influential customers are around the retailer's location. Alternatively, the retailer may use the information to decide on a new location (e.g., if the retailer is looking to open a new store). The method 400 ends at step 414.

It should be noted that although not explicitly specified, one or more steps or operation of the method 400 described above may include a storing, displaying and/or outputting step as required for a particular application. In other words, any data, records, fields, and/or intermediate results discussed in the methods can be stored, displayed, and/or outputted to another device as required for a particular application. Furthermore, steps, operations or blocks in FIG. 4 that recite a determining operation, or involve a decision, do not necessarily require that both branches of the determining operation be practiced. In other words, one of the branches of the determining operation can be deemed as an optional step.

FIG. 5 depicts a high-level block diagram of a general-purpose computer suitable for use in performing the functions described herein. As depicted in FIG. 5, the system 500 comprises one or more hardware processor elements 502 (e.g., a central processing unit (CPU), a microprocessor, or a multi-core processor), a memory 504, e.g., random access memory (RAM) and/or read only memory (ROM), a module 505 for creating a map representing the location of subscribers with their respective aggregate subscriber affluence score, and various input/output devices 506 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the general-purpose computer may employ a plurality of processor elements. Furthermore, although only one general-purpose computer is shown in the figure, if the method(s) as discussed above is implemented in a distributed or parallel manner for a particular illustrative example, i.e., the steps of the above method(s) or the entire method(s) are implemented across multiple or parallel general-purpose computers, then the general-purpose computer of this figure is intended to represent each of those multiple general-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a general purpose computer or any other hardware equivalents, e.g., computer readable instructions pertaining to the method(s) discussed above can be used to configure a hardware processor to perform the steps, functions and/or operations of the above disclosed methods. In one embodiment, instructions and data for the present module or process 505 for creating a map representing the location of subscribers with their respective aggregate subscriber affluence score (e.g., a software program comprising computer-executable instructions) can be loaded into memory 504 and executed by hardware processor element 502 to implement the steps, functions or operations as discussed above in connection with the exemplary method 400. Furthermore, when a hardware processor executes instructions to perform “operations”, this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 505 for creating a map representing the location of subscribers with their respective aggregate subscriber affluence score (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for creating a map, comprising:
receiving, by a processor, location data for at least one subscriber of a communications network service provider;
calculating, by the processor, an aggregate subscriber affluence score of the at least one subscriber, wherein the aggregate subscriber affluence score is based upon an affluence score weighted by an influence parameter; and
creating, by the processor, the map representing a location that the at least one subscriber has visited with an indication of the aggregate subscriber affluence score of the at least one subscriber.

2. The method of claim 1, wherein the at least one subscriber comprises a plurality of subscribers and the location data is received for each one of the plurality of subscribers.

3. The method of claim 2, wherein the aggregate subscriber affluence score is calculated for each one of the plurality of subscribers.

4. The method of claim 2, wherein the map comprises a location that each one of a predefined number of the plurality of subscribers having a respective aggregate subscriber affluence score above a threshold has visited with a respective indication of the respective aggregate subscriber affluence score of each one of the predefined number of the plurality of subscribers.

5. The method of claim 4, wherein the respective indication for each one of the predefined number of the plurality of subscribers has a different type of indication based upon a scoring level of the respective aggregate subscriber affluence score.

6. The method of claim 1, wherein the affluence score comprises a function of different categories of demographic information of the at least one subscriber.

7. The method of claim 6, wherein a weighting of each one of the different categories is defined by a retailer requesting the map.

8. The method of claim 1, wherein the influence parameter comprises a function of a number of communications with each one of a predefined number of a plurality of contacts of the at least one subscriber and a respective affluence score of each one of the predefined number of the plurality of contacts.

9. The method of claim 1, wherein the location data for the at least one subscriber is obtained using a location based service.

10. The method of claim 1, wherein the location data for the at least one subscriber is obtained for a pre-defined time period.

11. The method of claim 1, wherein the location data for the at least one subscriber is tracked in real-time.

12. The method of claim 1, wherein the map is divided into a plurality of pre-defined bins and the location data is mapped into the plurality of pre-defined bins of the map.

13. A computer-readable storage device storing a plurality of instructions which, when executed by a processor, cause the processor to perform operations for creating a map, the operations comprising:
receiving location data for at least one subscriber of a communications network service provider;
calculating an aggregate subscriber affluence score of the at least one subscriber, wherein the aggregate subscriber affluence score is based upon an affluence score weighted by an influence parameter; and
creating the map representing a location that the at least one subscriber has visited with an indication of the aggregate subscriber affluence score of the at least one subscriber.

14. The computer-readable storage device of claim 13, wherein the at least one subscriber comprises a plurality of subscribers and the location data is received for each one of the plurality of subscribers.

15. The computer-readable storage device of claim 14, wherein the aggregate subscriber affluence score is calculated for each one of the plurality of subscribers.

16. The computer-readable storage device of claim 14, wherein the map comprises a location that each one of a predefined number of the plurality of subscribers having a respective aggregate subscriber affluence score above a threshold has visited with a respective indication of the respective aggregate subscriber affluence score of each one of the predefined number of the plurality of subscribers.

17. The computer-readable storage device of claim 16, wherein the respective indication for each one of the predefined number of the plurality of subscribers has a different type of indication based upon a scoring level of the respective aggregate subscriber affluence score.

18. The computer-readable storage device of claim 13, wherein the affluence score comprises a function of different categories of demographic information of the at least one subscriber.

19. The computer-readable storage device of claim 18, wherein a weighting of each one of the different categories is defined by a retailer requesting the map.

20. An apparatus for creating a map, comprising:
a processor; and
a computer-readable storage device storing a plurality of instructions which, when executed by the processor, cause the processor to perform operations, the operations comprising:
receiving location data for at least one subscriber of a communications network service provider;
calculating an aggregate subscriber affluence score of the at least one subscriber, wherein the aggregate subscriber affluence score is based upon an affluence score weighted by an influence parameter; and
creating the map representing a location that the at least one subscriber has visited with an indication of the aggregate subscriber affluence score of the at least one subscriber.
